(19) United States
(12) Patent Application Publication
(10) Pub. No.: US 2023/0182415 A1
(43) Pub. Date: Jun. 15, 2023

(54) METHOD FOR MANUFACTURING FIBER-REINFORCED RESIN TUBE BODY

(71) Applicants: Hitachi Astemo, Ltd., Ibaraki (JP); Kanazawa Institute of Technology, Ishikawa (JP)

(72) Inventors: Takahiro Nakayama, Ibaraki (JP); Fumiya Takahashi, Ibaraki (JP); Kiyoshi Uzawa, Ishikawa (JP); Katsuhiko Nunotani, Ishikawa (JP)

(21) Appl. No.: 18/106,314

(22) Filed: Feb. 6, 2023

Related U.S. Application Data
(63) Continuation of application No. PCT/JP2021/034043, filed on Sep. 16, 2021.

(30) Foreign Application Priority Data
Sep. 24, 2020 (JP) 2020-159548

(51) Int. Cl. B29C 70/48; B29C 70/54; B29C 70/46; B29C 70/70

(52) U.S. Cl. CPC B29C 70/48; B29C 70/548; B29C 70/462; B29C 70/70; B29L 2023/22

(57) ABSTRACT

A method for manufacturing a fiber-reinforced resin tube body includes: a preparing step of preparing a cylindrical expandable body having fiber wound therearound; an installing step of installing the expandable body in a mold after the preparing step; a flowing step of flowing resin into the mold, in which the expandable body is placed, after the installing step; and an expanding step of expanding the expandable body toward an inner wall of the mold after the flowing step.

### CROSS-REFERENCE TO RELATED APPLICATIONS

This application is a continuation application based on PCT/JP2021/034043, filed on Sep. 16, 2021, claiming priority based on Japanese Patent Application No. 2020-159548, filed on Sep. 24, 2020, the contents of which are incorporated herein by reference.

### TECHNICAL FIELD

The present invention relates to a method for manufacturing a fiber-reinforced resin tube body.

### RELATED ART

JP 2003-127257 A describes that, as a method for manufacturing a fiber-reinforced resin tube body, a fiber member impregnated with resin is wound around a mandrel by filament winding method, and the fiber member impregnated with resin is cured by autoclave treatment.

JP H08-323870 A describes so-called RTM (resin transfer molding) technology, in which a fiber-reinforced resin tube body is molded by placing a preform product made of a laminated fiber body or the like in a mold, followed by introducing resin into the mold to impregnate the fiber body with the resin.

In the course of researching the manufacture of fiber-reinforced resin tube bodies by RTM molding, Applicants found that impregnating a fiber body with resin from its radial direction (lamination direction) contributes to improvement of the molding quality, rather than impregnating from its longitudinal direction.

On the other hand, in order to increase the flow rate of resin, it is necessary to provide a space outside the fiber body in the radial direction (lamination direction). However, this space increases the amount of resin used for the fiber-reinforced resin tube body as an end product, which disadvantageously increases the mass of the fiber-reinforced resin tube body.

The present invention has been created to solve these problems, and an object of the present invention is to provide a method for manufacturing a fiber-reinforced resin tube body, by which the molding quality can be improved and an increase in the mass can be suppressed.

### SUMMARY OF THE INVENTION

To solve the above problem, the present invention provides a method for manufacturing a fiber-reinforced resin tube body comprising: a preparing step of preparing a cylindrical expandable body having fiber wound therearound; an installing step of installing the expandable body in a mold after the preparing step; a flowing step of flowing resin into the mold, in which the expandable body is placed, after the installing step; and an expanding step of expanding the expandable body toward an inner wall of the mold after the flowing step.

The present invention can provide a method for manufacturing a fiber-reinforced resin tube body, by which the molding quality can be improved and an increase in the mass can be suppressed.

### BRIEF DESCRIPTION OF THE DRAWINGS

FIG. 1 is a side view of a power transmission shaft.

FIG. 2 is a cross-sectional view of a main body of a tube body used in the power transmission shaft, taken along an axial direction thereof.

FIG. 3 is a flowchart of manufacturing a tube body according to a first embodiment.

FIG. 4 illustrates a preparing step in the manufacturing method of the tube body according to the first embodiment.

FIG. 5 illustrates a decompressing step in the manufacturing method of the tube body according to the first embodiment.

FIG. 6 illustrates a flowing step in the manufacturing method of the tube body according to the first embodiment.

FIG. 7 illustrates an expanding step and a curing step in the manufacturing method of the tube body according to the first embodiment.

FIG. 8 is an enlarged view of A portion shown in FIG. 7.

FIG. 9 illustrates a curing step in the manufacturing method of the tube body according to a modification of the first embodiment.

FIG. 10 is a partially broken side view illustrating an expandable body according to a second embodiment.

FIG. 11 is a cross-sectional view illustrating a state in which the expandable body according to the second embodiment is installed in a mold.

FIG. 12 is an enlarged view of XII portion shown in FIG. 11.

FIG. 13A is a cross-sectional view illustrating a portion of a first modification corresponding to the portion taken along the line XIII-XIII of FIG. 12.

FIG. 13B is a cross-sectional view illustrating a portion of a second modification corresponding to the portion taken along the line XIII-XIII of FIG. 12.

FIG. 14 is a cross-sectional view illustrating a first installing step according to a third embodiment.

FIG. 15 is a cross-sectional view illustrating a second installing step according to the third embodiment.

FIG. 16 is a cross-sectional view illustrating a flowing step according to a fourth embodiment.

### DETAILED DESCRIPTION OF THE INVENTION

Next, the present invention will be described as an example of a case where it is applied to a method for manufacturing a tube body used in a power transmission shaft, with reference to the drawings. Technical elements common to various embodiments and modifications are denoted by common reference numerals and descriptions thereof will be omitted. First, a description will be given of a power transmission shaft to be manufactured by the method for manufacturing a tube body.

### Power Transmission Shaft

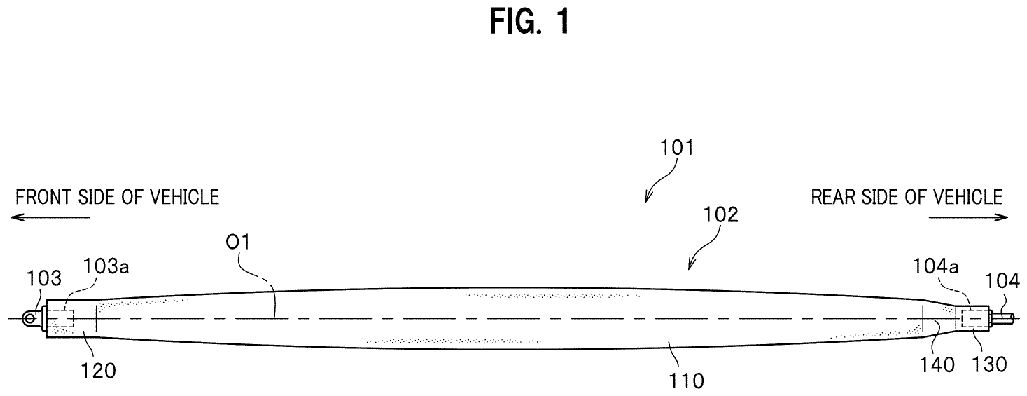

As shown in FIG. 1, a power transmission shaft 101 is a propeller shaft mounted on a front-engine front-drive (FF) based four-wheel drive vehicle. The power transmission shaft 101 includes a tube body 102 having a substantially circular cylindrical shape and extending in a front-rear direction of a vehicle, a stub yoke 103 of a cross shaft joint joined to a front end of the tube body 102, and a stub shaft 104 of a constant velocity joint joined to a rear end of the tube body 102.

The stub yoke 103 is a coupling member to couple a transmission mounted at a front part of a vehicle body with the tube body 102. The stub shaft 104 is a coupling member to couple a final reduction gear mounted at a rear part of the vehicle body with the tube body 102.

When power (torque) is transmitted from the transmission, the power transmission shaft 101 rotates about an axis O1 and transmits the power to the final reduction gear.

The tube body 102 as a fiber-reinforced resin tube body is formed of carbon fiber reinforced plastic (CFRP).

A fiber layer formed of fibers circumferentially extending about the axis O1 and a fiber layer formed of fibers extending along the axis 01 are stacked inside the tube body 102. This allows the tube body 102 to have high mechanical strength and high elasticity along the axis O1. PAN (Polyacrylonitrile) fiber is preferred as fibers oriented in the circumferential direction, and pitch fibers are preferred as fibers oriented along the axis O1.

It should be noted that according to the present invention, the fibers used in the fiber-reinforced plastic are not limited to carbon fibers and may be glass fibers or aramid fibers.

The tube body 102 includes a main body 110 that makes up the majority of the tube body 102, a first connection portion 120 disposed at a front side of the main body 110, a second connection portion 130 disposed at a rear side of the main body 110, and an inclined portion 140 located between the main body 110 and the second connection portion 130.

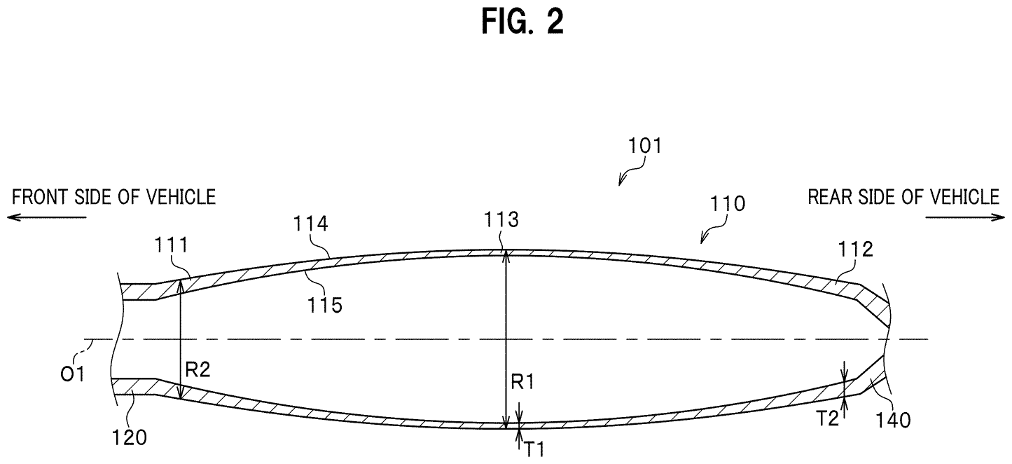

It should be noted that a shape of the tube body 102 is exaggeratedly depicted in FIG. 2 and subsequent figures for the purpose of easy understanding of the shape of the tube body 102.

As shown in FIG. 2, the first connection portion 120 continues to a front end portion 111 of the main body 110, and the inclined portion 140 continues to a rear end portion 112 of the main body 110.

When the main body 110 is sectioned in a plane normal to the axis O1, an outer periphery 114 and an inner periphery 115 of the main body 110 each have a cross-section in a circular shape. An outer diameter of the main body 110 decreases from a central portion 113 toward both end portions (the rear end portion 112 as one end portion, and the front end portion 111 as the other end portion), and an outer diameter R1 of the central portion 113 is larger than outer diameters R2 of both end portions (the front and rear end portions 111, 112).

It should be noted that an inner diameter of the main body 110 also decreases from the central portion 113 of the main body 110 toward both end portions (the front and rear end portions 111, 112).

When the main body 110 is sectioned along the axis O1, the outer periphery 114 and the inner periphery 115 of the main body 110 each have a cross section gently curved and the central portion 113 protrudes outward in an arc. Accordingly, the outer shape of the main body 110 has a barrel shape, with the central portion 113 bulging radially outward. With respect to the cross-sectional shapes, the thickness of the main body 110 decreases from both end portions (the front and rear end portions 111, 112) toward the central portion 113, and the thickness T1 of the central portion 113 is smaller than the thickness T2 of both end portions (the front and rear end portions 111, 112).

As shown in FIG. 1, a shaft portion 103a of the stub yoke 103 is fitted into the first connection portion 120. The outer periphery of the shaft portion 103a is formed in a polygonal shape. The first connection portion 120 has an inner periphery thereof formed in a polygonal shape, to follow the outer periphery of the shaft portion 103a. This configuration prevents the stub yoke 103 and the tube body 102 from rotating relative to each other.

A shaft portion 104a of the stub shaft 104 is fitted into the second connection portion 130. The second connection portion 130 has an inner periphery thereof formed in a polygonal shape, to follow the outer periphery of the shaft portion 104a. This configuration prevents the stub shaft 104a and the tube body 102 from rotating relative to each other.

An outer diameter of the inclined portion 140 gradually decreases from the main body 110 toward the second connection portion 130, to have a conical frustrum shape. The thickness of the inclined portion 140 gradually decreases from an end portion thereof closer to the second connection portion 130 (rear side) toward an end portion thereof closer to the main body 110 (front side). This causes the inclined portion 140 to have the smallest thickness at a front end portion thereof as a weakened portion.

Based on the above configuration, if a vehicle is collided head-on to have a collision load inputted to the power transmission shaft 101, a shear force acts on the inclined portion 140 that is inclined with respect to the axis O1. If the shear force acting on the inclined portion 140 exceeds a predetermined value, the front end portion (weakened portion) of the inclined portion 140 is damaged. This allows the engine and the transmission mounted on the front part of the vehicle body to be quickly moved rearward, in the event of a vehicle collision, to absorb the collision energy by the front part of the vehicle body.

According to the above-described tube body 102, the central portion 113 of the main body 110, where bending stress is likely concentrated, has the outer diameter R1 increased to have a predetermined bending rigidity. In contrast, both end portions of the main body 110 (the front and rear end portions 111, 112), where bending stresses are less likely concentrated, have the outer diameter R2 decreased so as to be reduced in weight. Further, the central portion 113 of the main body 110 has the small thickness T1 to have a reduced weight. Then, the tube body 102 has the main body 110 reduced in weight while maintaining a predetermined bending rigidity at the central portion 113, to improve the primary bending resonance point of the tube body 102.

### First Embodiment

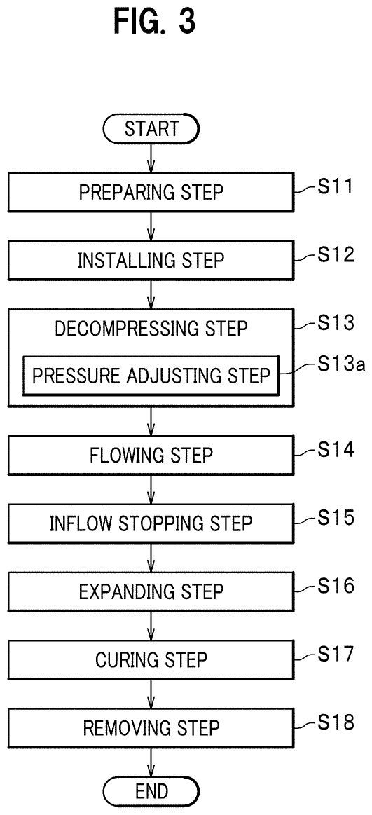

As shown in FIGS. 3 to 6 (see also FIGS. 1 and 2, where appropriate), a manufacturing method according to a first embodiment includes: a preparing step (step S11) of preparing an expandable body 72 having fiber 71 wound therearound; an installing step (step S12) of installing the expandable body 72 in a mold 61; a decompressing step (step S13) of decompressing an inside of the mold 61; a flowing step (step S14) of flowing uncured resin into the mold 61, in which the expandable body 72 is placed; an inflow stopping step (step S15) of stopping an inflow of the resin; an expanding step (step S16) of expanding the expandable body 72 by supplying a fluid into the expandable body 72; a curing step (step S17) of curing the uncured resin; and a removing step (step S18) of removing a tube body 102 from the mold 61.

### Preparing Step

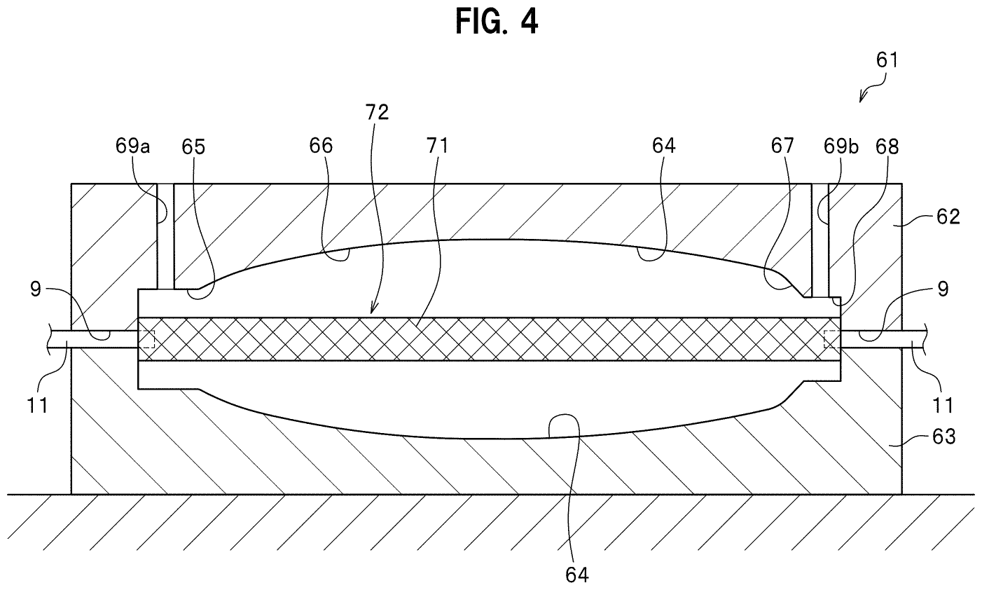

As shown in FIG. 4, the preparing step (step S11) involves preparing a mold 61 and an expandable body 72. The mold 61 includes an upper mold 62 and a lower mold 63. A cavity surface 64 is formed on a lower surface of the upper mold 62 and an upper surface of the lower mold 63 to form an outer shape of the tube body 102.

The cavity surface 64 is elongated in one direction. The cavity surface 64 has, in the order from the other end in a longitudinal direction thereof toward one end, a first-connection-portion mold area 65, a main-body mold area 66, an inclined-portion mold area 67, and a second-connection-portion mold area 68.

The first-connection-portion mold area 65 is an area to form an outer shape of the first connection portion 120 of the tube body 102. The main-body mold area 66 is an area to form an outer shape of the main body 110. The inclined-portion mold area 67 is an area to form an outer shape of the inclined portion 140. The second-connection-portion mold area 68 is an area to form an outer shape of the second connection portion 130.

The lower surface of the upper mold 62 and the upper surface of the lower mold 63 have two communicating holes 9 to communicate the inside of the mold 61 with outside when the mold 61 is tightened. One of the communicating holes 9 is disposed on the other end portion of the first-connection-portion mold area 65, and another is disposed on one end portion of the second-connection-portion mold area 68.

The mold 61 has an inflow gate 69a for supplying resin into the mold 61 and a discharge gate 69b for discharging extra resin. The inflow gate 69a is located at the first-connection-portion mold area 65, and the discharge gate 69b is located at the second-connection-portion mold area 68.

The expandable body 72 is a cylindrical resin member having dry fiber 71, which is not impregnated with resin, wound therearound. The expandable body 72 expands in accordance with the amount of fluid flowing inside the expandable body 72. The resin member is a so-called mandrel, and is made of a material having heat resistance to high-temperature fluid, such as silicone rubber, fluoro rubber, acrylic rubber, urethane resin and elastomer, PET (polyethylene terephthalate), PEN (polyethylene naphthalate), and PC (polycarbonate). A supply pipe 11 is connected to each end of the expandable body 72.

The fiber 71 is used to reinforce the strength of the tube body 102, and may be carbon fiber, glass fiber, or aramid fiber. It should be noted that a technique of winding the fiber 71 and orientation of the fiber 71 are not particularly limited.

In the preparing step, the expandable body 72 as an intermediate is prepared by winding the fiber 71 around the outer periphery of the tubular resin member. Although not shown in the drawings, as an example, the expandable body 72 includes a cylindrical resin member, and first to third layers laminated on an outer periphery of the resin member in this order; the first layer is composed of fiber disposed parallel to the axis center of the cylindrical resin member, the second layer is composed of fiber inclined at an angle of +45° to the axis center and wound around the first layer, and the third layer is composed of fiber inclined at an angle of −45° to the axis center and wound around the second layer.

### Installing Step

As shown in FIG. 4, the installing step (step S12) is a step of installing an expandable body 72 inside the mold 61. To be more specific, the mold 61 is opened, the expandable body 72 is placed on the lower mold 63, and the upper mold 62 is combined from above the lower mold 63 to close the mold 63.

The expandable body 72 is arranged to be engaged with an end of a supply pipe 11 that penetrates a communicating hole 9. This makes it possible to fix the expandable body 72 inside the mold 61 while the expandable body 72 is spaced apart from the cavity surface 61.

### Decompressing Step

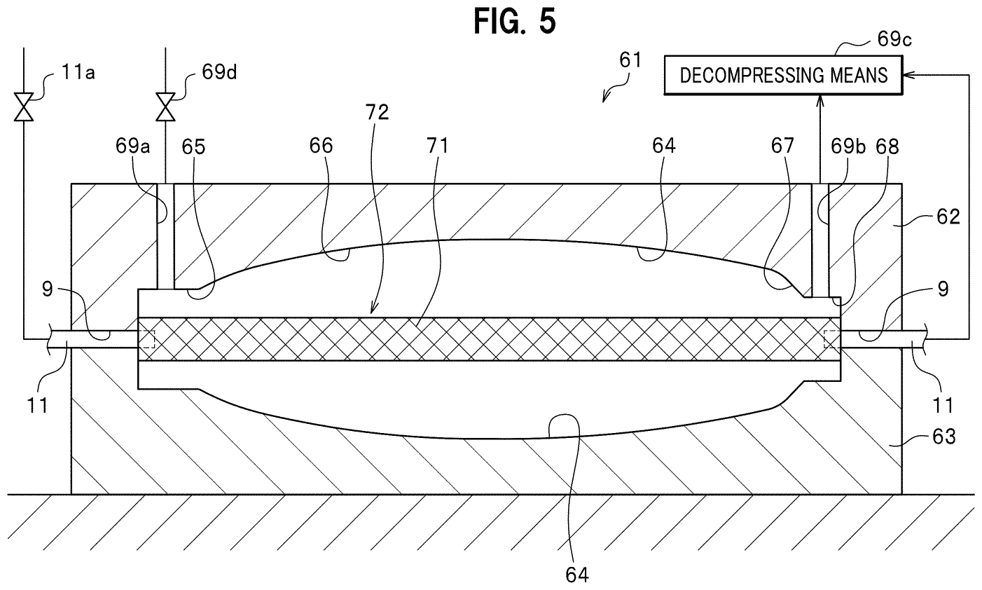

As shown in FIG. 5, the decompressing step (step S13) is a step of decompressing the internal space of the mold 61 while the expandable body 72 is placed in the mold 61. To be more specific, a fluid in the internal space of the mold 61 is sucked out of a discharge gate 69b, for example, using a decompressing means (decompressing device) 69c. At this time, a valve 69d provided in the inflow gate 69a is closed. Accordingly, the internal pressure of the internal space of the mold 61 is set to a predetermined pressure, for example, below the atmospheric pressure.

The pressure adjusting step (step S13a) is a step of adjusting the pressure inside the expandable body 72 in response to the decompression in the mold 61. The pressure adjusting step is performed in parallel with the decompressing step. In other words, the decompressing step includes the pressure adjusting step.

For example, the pressure adjusting step is performed to suck and decompress the fluid inside the expandable body 72 using the decompressing means 69c connected to one supply pipe 11 such that the pressure in the internal space of the mold 61 is equal to the pressure in the internal space of the expandable body 72. At this time, a valve 11a in the other supply pipe 11 is closed. This can prevent the expandable body 72 from expanding as a result of decompression inside the mold 61. For example, the pressure adjusting step is controlled based on measured values of a pressure sensor that measures the pressure inside the mold 61 or the expandable body 72. It should be noted that the pressure adjusting step may be performed by filling the expandable body 72 with a liquid such as water, instead of sucking the fluid (gas) inside the expandable body 72.

### Flowing Step

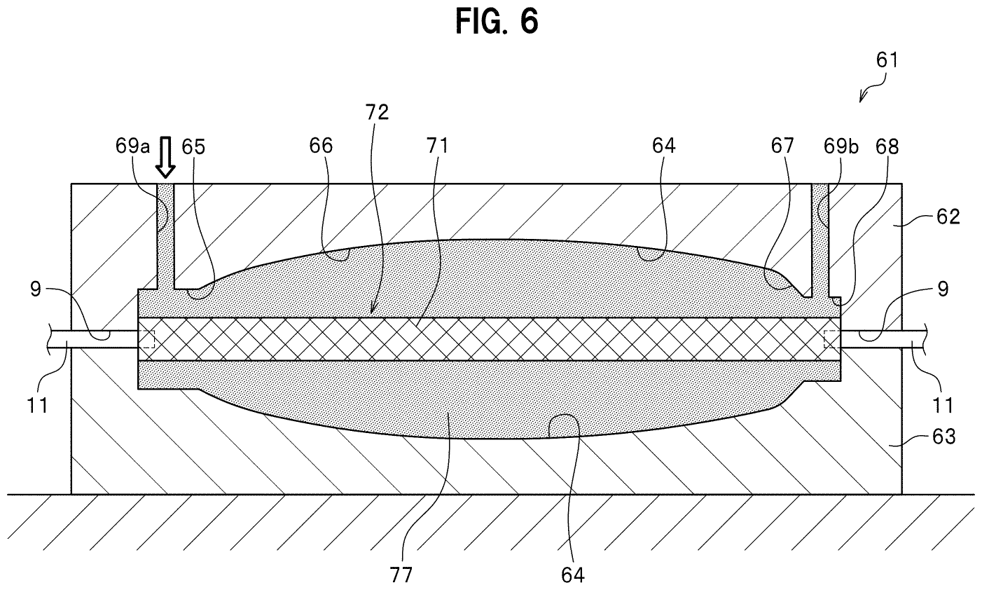

As shown in FIG. 6, the flowing step (step S14) involves flowing uncured thermosetting resin 77 into the mold 61 through the inflow gate 69a. This causes the uncured thermosetting resin 77 to be filled in the space between the unexpanded expandable body 72 (before expansion of the expandable body 72) and the cavity surface 64. Since the decompressing step of decompressing the inside of the mold 61 is included before the flowing step, the supply of resin into the mold 61 in the axial direction can be performed quickly. It should be noted that short fiber may be mixed with and supplied in the thermosetting resin 77. Further, it is not always necessary to fill the mold with the thermosetting resin 77, and the amount of the thermosetting resin supplied in the mold may be adjusted in consideration of the amount of the carbon fiber wound and the thickness of a resin layer to be described later.

The flowing step is performed before the expanding step, so that the thermosetting resin 77 flows while a clearance between the expandable body 72 and the cavity surface 64 is large. This can increase the flow rate of the thermosetting resin 77.

### Inflow Stopping Step

The inflow stopping step (step S15) is a step of stopping the inflow of the thermosetting resin 77. The inflow stopping step involves stopping the inflow of the thermosetting resin 77, for example, by closing the inflow gate 69a. At this time, the discharge gate 69b may be closed together with the inflow gate 69a or may remain open.

### Expanding Step

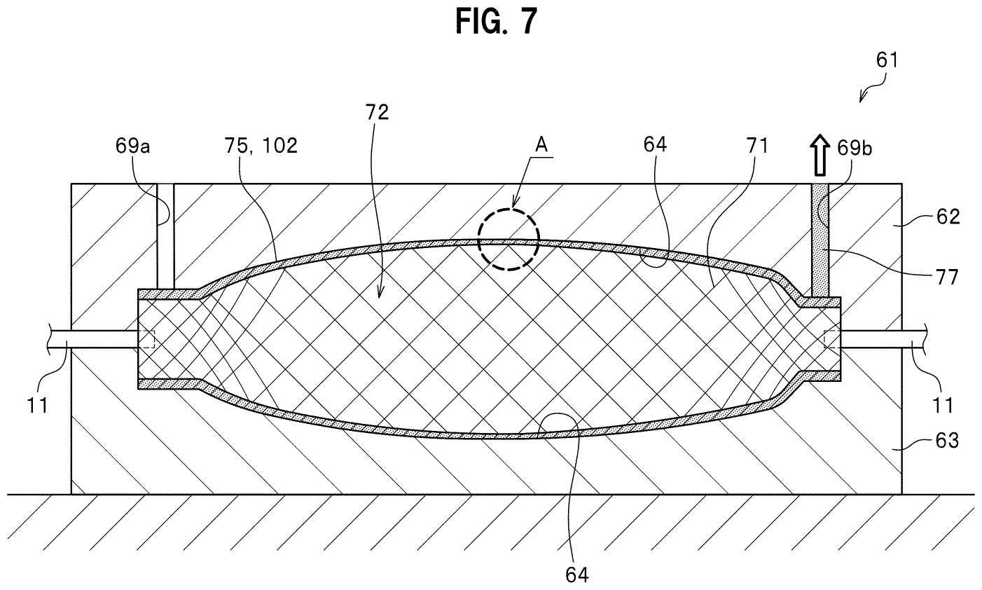

As shown in FIG. 7, the expanding step (step S16) involves supplying the fluid into the expandable body 72 from a heating device through the supply pipe 11. The heating device (not shown) is a device to generate and supply a fluid at a desired temperature. According to this embodiment, the fluid supplied from the heating device is liquid. The heating device supplies the fluid to such an extent that the expandable body 72 expands and the outer periphery of the expandable body 72 comes into proximity (or comes into contact) with the cavity surface 64. A gap is formed between the fibers 71 wound around the expandable body 72, and this gap is increased by the expanding step. It should be noted that liquid is used as the fluid in this embodiment, but gas may be used. Further, the fluid may be supplied without using a heating device, and the mold may be heated in the subsequent curing process.

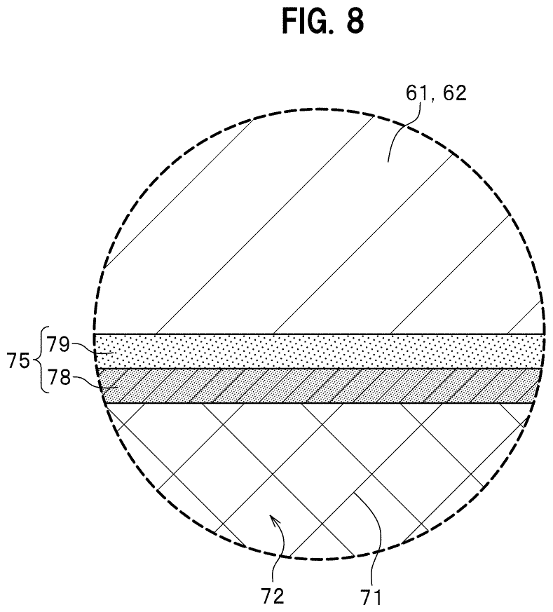

When the expandable body 72 is expanded by the fluid, the expandable body 72 is pressed against the uncured thermosetting resin 77 having filled in the space radially outside the expandable body 72. Accordingly, the thermosetting resin 77 permeates the gap formed between the fibers 71 arranged around the expandable body 72 from radially outside the expandable body 72. Further, adjusting the amount of expansion of the expandable body 72 and providing a gap between the fibers 71 wound around the expandable body 72 and the cavity surface 64 makes it possible to uniformly form a layer of the thermosetting resin 77 (a resin layer 79 to be described later, see FIG. 8) between the fibers 71 and the cavity surface 64 (in other words, outside the fibers 71 in the radially outer direction of the expandable body).

Excess thermosetting resin 77 is discharged from the discharge gate 69b by the pressure caused when the expandable body 72 expands. The amount of opening and closing of the discharge gate 69b can be adjusted to prevent the liquid pressure of the thermosetting resin 77 from lowering too much.

### Curing Step

In the curing step (step S17), one of the two supply pipes 11 drains the fluid inside the expandable body 72, while the other supply pipe 11 supplies hot fluid into the expandable body 72. The temperature of the fluid to be supplied in the curing step is set to a temperature at which the resin can be cured (e.g., 130° C. to 180° C.). According to this step, the temperature of the fluid is transmitted to the thermosetting resin 77 through the expandable body 72, and the thermosetting resin 77 hardens, so that a resin body 75 is formed and a tube body 102 made of fiber-reinforced resin is formed in the end.

Other than the method described in this embodiment, the curing step may involve a method of using and heating the mold 61 to cure the thermosetting resin 77. Further, heating can be performed by employing both of the method of using the mold 61 and the method of supplying hot fluid into the expandable body 72.

As shown in FIG. 8, the resin body 75 according to this embodiment has a two-layer structure including a fiber layer 78 and a resin layer 79. The fiber layer 78 consists of resin-impregnated fiber and is located radially inside. The resin layer 79 is formed of resin having flowed radially outside the fiber layer 78 in the flowing step to protect the fiber layer 78. The resin layer 79 covers the surface of the fiber layer 78. This can protect the fiber layer 78. According to this embodiment, the resin layer 79 does not contain the fiber 71 wound around the expandable body 72 in the preparing step.

Further, the curing step (step S17) may involve heating the mold 61 using a heater (not shown) or the like. This makes it possible to apply heat to the resin body 75 from the cavity surface 64 of the mold 61, so that the heating time of the resin body 75 is shortened.

### Removing Step

The removing step (step S18) is a step of removing the tube body 102 from the mold 61. In the removing step, the fluid in the expandable body 72 is first discharged. This causes the inner pressure of the expandable body 72 to be reduced so that the expandable body 72 restores the original cylindrical shape. Next, the mold 61 is opened to remove the tube body 102. Then, the expandable body 72 (more specifically, the resin member as a mandrel) is removed from the tube body 102, so that the tube body 102 is completed. It should be noted that removal of the expandable body 72 is not always necessary and that the expandable body 72 may be used as a core material without restoring it to its original shape.

### Operation and Effects of First Embodiment

The method for manufacturing a tube body 102 according to the first embodiment includes, at least: a preparing step (step S11) of preparing a cylindrical expandable body 72 having fiber 71 wound therearound; an installing step (step S12) of installing the expandable body 72 in a mold 61 after the preparing step; a flowing step (step S14) of flowing uncured thermosetting resin 77 into the mold 61, in which the expandable body 72 is placed; and an expanding step (step S16) of expanding the expandable body 72 by supplying fluid into the expandable body 72.

According to this manufacturing method, since the cylindrical expandable body 72 having fiber 71 wound therearound is installed in an unexpanded state in the mold 61 in the installing step (step S12), a clearance between the fiber 71 and the mold 61 can be ensured. Further, since the flowing step (step S14) is performed before the expanding step (step S16), the resin can be supplied into the mold 61 while the clearance between the fiber 71 and the mold 61 is large. This makes it possible to distribute the resin to every corner of the mold 61.

Further, since the expandable body 72 is expanded in the expanding step (step S16) and the thermosetting resin 77 is discharged, the resin body 75 can be made thinner (with smaller clearance) to suppress the mass of the tube body 102. As compared with a normal RTM (resin transfer molding) molding without providing an expanding step, this manufacturing method can increase the fiber content of the tube body 102.

The method for manufacturing a tube body 102 according to the first embodiment performs the flowing step (step S14) of filling the clearance with resin prior to the expanding step (step S16) of expanding the expandable body 72. This allows the resin to permeate gaps formed between the fibers 71 from radially outside the expandable body 72 in the expanding step (step S16).

Accordingly, the molding quality of resin can be improved as compared with an alternative method, in which resin is supplied to spaces between fibers 71 along the axial direction of the expandable body 72 after expansion of the expandable body 72.

Further, since resin can be filled in a state where the clearance between the fiber 71 and the mold 61 is large before expansion of the expanding mandrel, the resin can be injected at a low pressure and large flow rate. This can improve the production speed and simplify equipment, such as a mold and a clamping machine, as compared with that required for flowing resin under high pressure.

As a comparative example, when resin-impregnated fiber is wound around a mandrel and autoclave molding is performed to form a tube body, a torque generated by winding the fiber causes the impregnated resin to seep out from the fiber, so that a resin layer (a layer made of resin only) is formed outside the fiber layer. In this case, the thickness of the resin layer is less likely to be uniform, and the protective performance of the fiber layer is reduced.

In contrast, the method for manufacturing a fiber-reinforced resin tube body according to the first embodiment includes the expanding step of expanding the expandable body in a state where sufficient resin is present radially outside the expandable body 72, so that a resin layer 79 (see FIG. 8) having a high degree of thickness uniformity in the axial and the circumferential directions of the expandable body 72 can be formed by adjusting the amount of expansion of the expandable body 72.

Further, the method for manufacturing a tube body 102 according to the first embodiment includes, after the installing step (step S12) and before the flowing step (step S14), the decompressing step (step S13) of decompressing the inside of the mold 61. This makes it possible to quickly supply thermosetting resin 77 into the mold 61 in the axial direction during the flowing step.

Further, the decompressing step (step S13) includes the pressure adjusting step (step S13a) of adjusting pressure inside the expandable body 72 in response to decompressing the inside of the mold 61. This makes it possible to synchronize the decompression in the mold 61 and the decompression in the expandable body 72 to prevent the expandable body 72 from unintentionally expanding due to the decompression in the mold 61.

Further, the method for manufacturing a tube body 102 according to the first embodiment includes, after the flowing step (step S14) and before the expanding step (step S16), the inflow stopping step (step S15) of stopping an inflow of thermosetting resin 77. This makes it possible to suppress waste of the thermosetting resin 77.

### Modification of First Embodiment

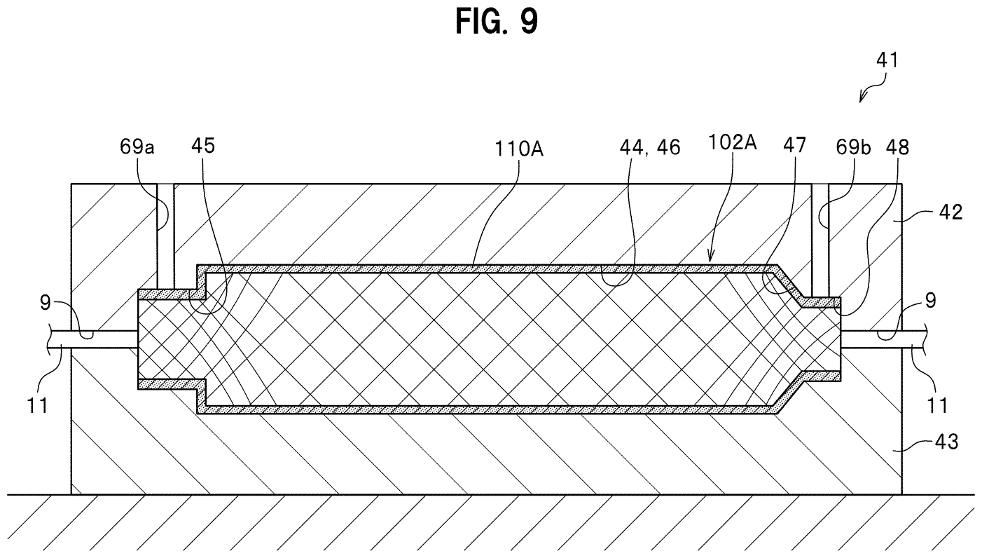

As shown in FIG. 9, a modification of the first embodiment is different from the first embodiment in that a mold 41 consisting of an upper mold 42 and a lower mold 43 used in a manufacturing method is different in shape from the mold 61 of the first embodiment. It should be noted that the steps from the preparing step (step S11) to the removing step (step S18) are basically the same as those described in the first embodiment.

The following explanation will be focused on differences from the first embodiment.

The cavity surface 44 of the mold 41 has a first-connection-portion mold area 45, a main-body mold area 46, an inclined-portion mold area 47, and a second-connection-portion mold area 48. The main-body mold area 46 has a constant diameter from the other end (first-connection-portion mold area 45) to one end (inclined-portion mold area 47). According to this mold 41, it is possible to manufacture a tube body 102A equipped with a cylindrical main body 110A having a constant diameter.

Although the first embodiment has been described above, the present invention is not limited to the above-described embodiment.

For example, the resin layer 79 made of resin only is formed radially outside the resin-impregnated fiber layer 78 by adjusting the amount of expansion of the expandable body 72. However, the expanding step may be performed by expanding the expandable body 72 until the fiber 71 contacts the cavity surface 64, so that the resin layer 79 is not formed.

Further, instead of thermosetting resin used in the first embodiment and its modification, resin that is curable by actions other than heat may be used as long as the resin is curable after injecting into the mold.

Further, the cavity surface of the mold may have a polygonal cross-sectional shape at a connection-portion mold area (the first-connection-portion mold area 65, 45 or the second-connection-portion mold area 68, 48) for a connection portion (the first connection portion 120 or the second connection portion 130) connected to the stub yoke 103 or the stub shaft 104. This make is possible to form the first connection portion 120 and the second connection portion 130 having a polygonal cross-sectional shape. Accordingly, an additional step of forming the first connection portion 120 and the second connection portion 130 to have a polygonal shape can be eliminated.

The tube body according to the present invention is not limited to a specific configuration such that the main body 110 thereof has a circular arc cross-sectional shape when cut along the axis O1. For example, the cross-sectional shape of the main body 110, when cut along the axis 01, may be a stepped shaped. In other words, the cross-sectional shape of the main-body mold area 66, 46, when cut in the longitudinal direction of the cavity surface of the mold, may be a stepped shape. Of course, the cross-sectional shape when cut along the plane normal to the axis 01 may be a circular shape, and the cross-sectional shape when cut along the axis O1 may have a straight line extending in the axial direction.

The fiber-reinforced resin tube body manufactured by the manufacturing method according to the present invention is not limited to a tube body used for the power transmission shaft as described above.

### Second Embodiment

Next, a method for manufacturing a fiber-reinforced resin tube body according to a second embodiment is described. The second embodiment is different from the first embodiment mainly in that a metal member is provided at a part of the expandable body and that an inflow gate is provided in the mold at a position corresponding to the metal member. Differences from the first embodiment will be described in detail below.

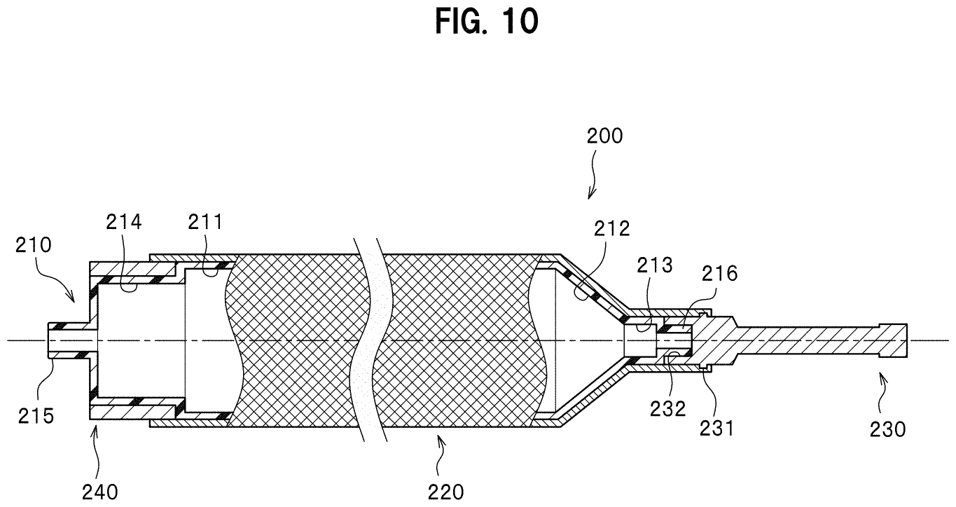

FIG. 10 is a partially broken side view illustrating an expandable body 200 according to the second embodiment.

As shown in FIG. 10, the expandable body 200 according to the second embodiment includes a mandrel 210, a first metal member 230 disposed at one end portion of the mandrel 210, a second metal member 240 disposed at the other end portion of the mandrel 210, and fiber 220 wound around these parts.

The mandrel 210 integrally includes a large diameter portion 211 at an axial middle portion thereof, a tapered portion 212 and a medium diameter portion 213 that are formed at one axial end portion thereof, and a stepped portion 214 and a small diameter portion 215 that are formed at the other axial end portion thereof. According to this embodiment, a protruding portion 216 having a diameter smaller than the medium diameter portion 213 is formed at the one axial end portion of the medium diameter portion 213. The mandrel 210 is made of a resin member expandable in the radial direction.

The first metal member 230 is a so-called stub shaft having a generally cylindrical shape. One axial end portion of the first metal member 230 is exposed from the fiber 220. An annular flange portion 231 is formed at an axial middle portion of the first metal member 230. Formed in the other axial end portion of the first metal member 230 is a bottomed hole 232 that is externally fitted onto the protruding portion 216 of the mandrel 210. The fiber 220 covers the first metal member 230 in a range from the other axial end portion thereof past the flange portion 231.

The second metal member 240 is a so-called collar having a generally cylindrical shape. The other axial end portion of the second metal member 240 is exposed from the fiber 220, and one axial end portion of the second metal member 240 is covered by the fiber 220. The second metal member 240 is externally fitted onto the stepped portion 214 of the mandrel 210.

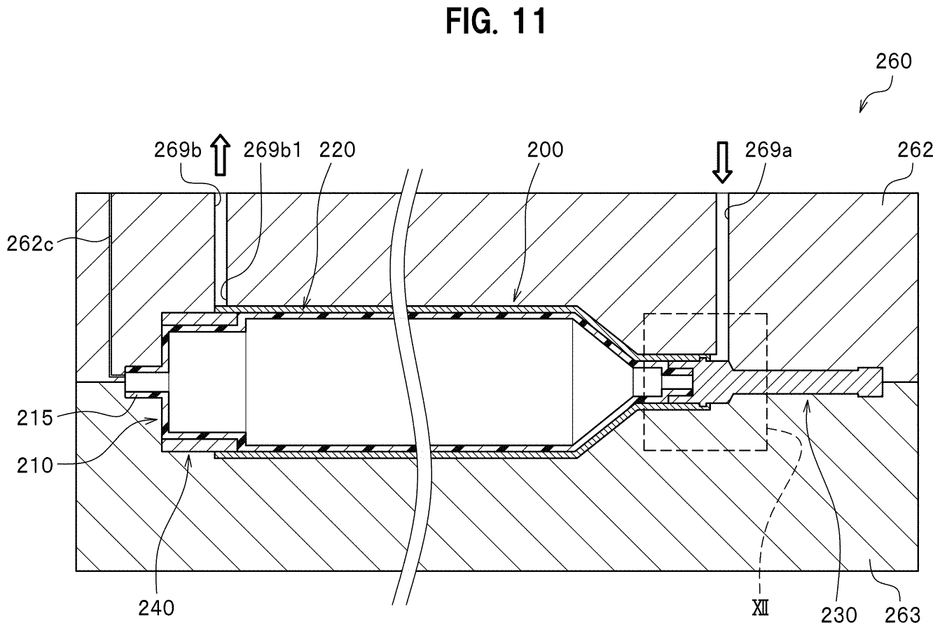

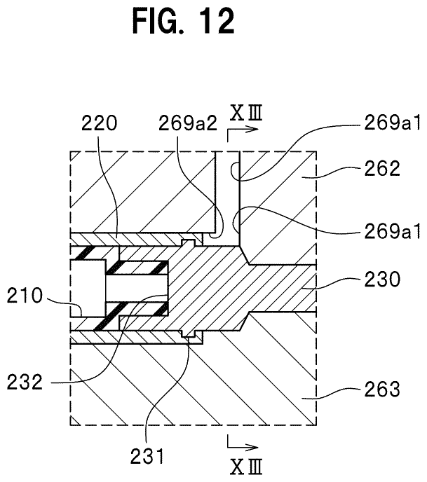

FIG. 11 is a cross-sectional view illustrating a state in which an expandable body 200 according to the second embodiment is installed in a mold 260. FIG. 12 is an enlarged view of XII portion shown in FIG. 11.

As shown in FIG. 11, the mold 260 includes an upper mold 262 and a lower mold 263. An inflow gate 269a provided in the upper mold 262 is disposed in a position corresponding to the first metal member 230. To be more specific, as shown in FIG. 12, a downstream end portion 269a1 of the inflow gate 269a is provided to open toward a portion of the first metal member 230 where the fiber 220 is not wound around. Further, a resin pool 269a2 is provided between the downstream end portion 269a1 of the inflow gate 269a and the end portion of the fiber 220.

It should be noted that as shown in FIG. 11, an outflow gate 269b provided in the upper mold 262 has an upstream end portion 269b1 that is disposed in a position corresponding to a portion of the second metal member 240 where the fiber 220 is wound around. However, as with the inflow gate 269a, the upstream end portion 269b1 of the outflow gate 269b may be disposed in a position corresponding to a portion of the second metal member 240 where the fiber 220 is not wound around.

Further, a fluid passage 262c for supplying fluid into or withdraw the fluid from the mandrel 210 is provided in the upper mold 262. The fluid passage 262c is in communication with an opening formed in an end portion of the small diameter portion 215.

In the method for manufacturing a fiber-reinforced resin tube body according to the second embodiment, the first metal member 230 is provided at one end portion of the expandable body 200, and the upper mold 262 is provided with the inflow gate 269a in a position corresponding to a portion of the first metal member 230 where the fiber 220 is not wound around. During the flowing step, resin flows from the inflow gate 269a toward the portion of the first metal member 230 where the fiber 220 is not wound around. The resin flowing into the mold 260 is supplied to the fiber 220 through the resin pool 269a2. This can prevent the arrangement of the fiber 220 from being disrupted due to the flow of resin flowing from the inflow gate 269a.

The other axial end portion of the first metal member 230 and the one axial end portion of the second metal member 240 are covered by the fiber 220. Therefore, the first metal member 230, the second metal member 240, and the fiber-reinforced resin tube body are integrated by performing RTM molding.

It should be noted that steps other than the flowing step are the same as those in the first embodiment, and explanation thereof will be omitted.

### First Modification of Second Embodiment

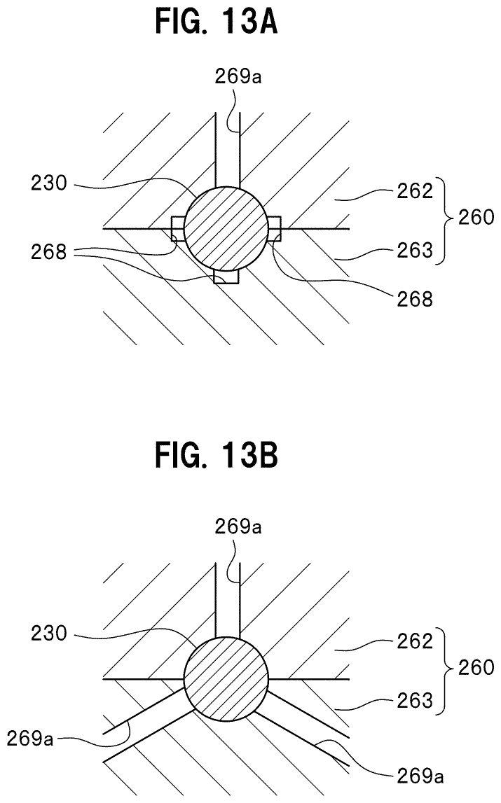

FIG. 13A is a cross-sectional view illustrating a portion of a first modification corresponding to the portion taken along the line XIII-XIII of FIG. 12.

As shown in FIG. 13A, a mold 260 according to the first modification has three recesses 268 at 90 degree intervals from the inflow gate 269a. When a fiber-reinforced resin tube body is manufactured using this mold 260, the outer periphery of the fiber-reinforced resin tube body has three resin-made projections corresponding to the three recesses 268 and formed at 90 degree intervals. A resin-made projection is left as a gate mark at a position corresponding to the inflow gate 269a.

Because the size of the resin-made projection as a gate mark is substantially constant with little variation from product to product, the size of the three recesses 268 is adjusted by estimating in advance the size of the resin-made projection as a gate mark. As a result, the resin-made projection as a gate mark and the three resin-made projections corresponding to the three recesses 268 are formed to have substantially the same size and at 90 degree intervals. Therefore, the circumferential weight balance of the fiber-reinforced resin tube body can be well-adjusted. It should be noted that the interval at which the recesses 268 are provided is not limited to 90 degrees as long as the recesses 268 are spaced apart at regular intervals from the inflow gate 269a.

### Second Modification of Second Embodiment

FIG. 13B is a cross-sectional view illustrating a portion of a second modification corresponding to the portion taken along the line XIII-XIII of FIG. 12.

As shown in FIG. 13B, a mold 260 according to the second modification is provided with three inflow gates 269a at positions spaced apart at 120 degree intervals in the circumferential direction of the fiber-reinforced resin tube body. According to this mold 260, resin-made projections as gate marks are formed at 120 degree intervals in the circumferential direction of the fiber-reinforced resin tube body. As a result, the circumferential weight balance of the fiber-reinforced resin tube body can be well-adjusted. Further, the molding speed for fiber-reinforced resin tube bodies can be increased. It should be noted that the interval at which the inflow gates 269a are provided is not limited to 120 degrees as long as the inflow gates 269a are spaced apart at regular intervals.

### Third Embodiment

Next, a method for manufacturing a fiber-reinforced resin tube body according to a third embodiment is described. The third embodiment is different from the first embodiment mainly in that a stepped portion is formed at a position of a mold corresponding to a metal member. Differences from the first embodiment will be described in detail below.

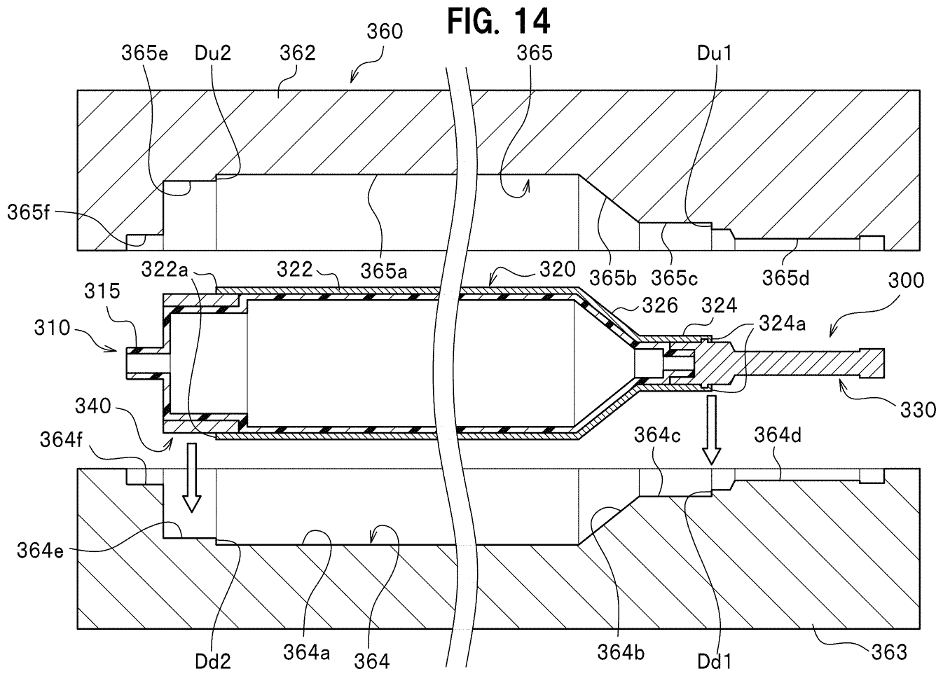

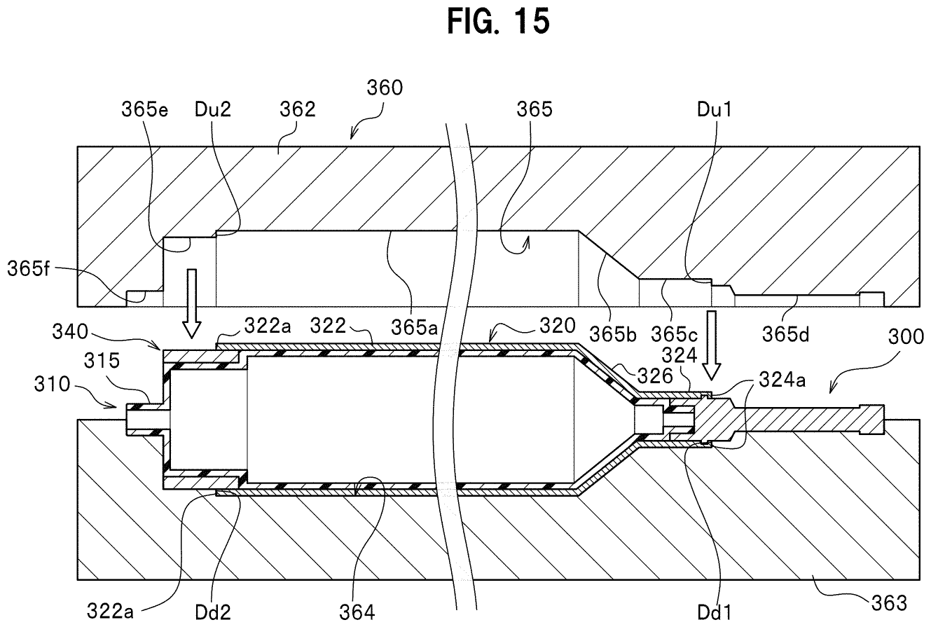

As shown in FIGS. 14 and 15, an expandable body 300 according to the third embodiment includes a cylindrical mandrel 310, a first metal member 330 disposed at one end portion of the mandrel 310, a second metal member 340 disposed at the other end portion of the mandrel 310, and fiber 320 wound around the mandrel 310. Further, a mold 360 according to the third embodiment includes an upper mold 362 and a lower mold 363. It should be noted that in FIGS. 14 and 15, various gates are omitted.

The fiber 320 is wound in a layered and cylindrical shape, and includes a thick diameter portion 322, a thin diameter portion 324 provided on the side of the first metal member 330 with respect to the thick diameter portion 322, and a tapered portion 326 provided between the thick diameter portion 322 and the thin diameter portion 324. The other end portion 322a of the thick diameter portion 322 overlaps one end portion of the second metal member 340. Further, one end portion 324a of the thin diameter portion 324 overlaps the other end portion of the first metal member 330.

The lower mold 363 has a lower cavity portion 364 having a recessed shape and formed to follow the outer shape of a lower half of the expandable body 300. The lower cavity portion 364 has a thick-diameter-portion lower cavity portion 364a, a thin-diameter-portion lower cavity portion 364c and a tapered-portion lower cavity portion 364b, a first-metal-member lower cavity portion 364d, a second-metal-member lower cavity portion 364e, and a small-diameter-portion lower cavity portion 364f. The thick-diameter-portion lower cavity portion 364a, the thin-diameter-portion lower cavity portion 364c and the tapered-portion lower cavity portion 364b correspond to the shape of the fiber 320 (more precisely, the shape of the fiber-reinforced resin tube body to be molded). The first-metal-member lower cavity portion 364d corresponds to the shape of a portion of the first metal member 330 where the fiber 320 is not wound around. The second-metal-member lower cavity portion 364e corresponds to the shape of a portion of the second metal member 340 where the fiber 320 is not wound around. The small-diameter-portion lower cavity portion 364f corresponds to a small diameter portion 315 of the mandrel 310. A first lower stepped portion Dd1 is formed at a boundary portion between the thin-diameter-portion lower cavity portion 364c and the first-metal-member lower cavity portion 364d. A second lower stepped portion Dd2 is formed at a boundary portion between the thick-diameter-portion lower cavity portion 364a and the second-metal-member lower cavity portion 364e.

Similarly, the upper mold 362 has an upper cavity portion 365 having a recessed shape and formed to follow the outer shape of an upper half of the expandable body 300. The upper cavity portion 365 has a thick-diameter-portion upper cavity portion 365a, a thin-diameter-portion upper cavity portion 365c and a tapered-portion upper cavity portion 365b, a first-metal-member upper cavity portion 365d, a second-metal-member upper cavity portion 365e, and a small-diameter-portion upper cavity portion 365f The thick-diameter-portion upper cavity portion 365a, the thin-diameter-portion upper cavity portion 365c and the tapered-portion upper cavity portion 365b correspond to the shape of the fiber 320. The first-metal-member upper cavity portion 365d corresponds to the shape of a portion of the first metal member 330 where the fiber 320 is not wound around. The second-metal-member upper cavity portion 365e corresponds to the shape of a portion of the second metal member 340 where the fiber 320 is not wound around. The small-diameter-portion upper cavity portion 365f corresponds to the small diameter portion 315 of the mandrel 310. A first upper stepped portion Du1 is formed at a boundary portion between the thin-diameter-portion upper cavity portion 365c and the first-metal-member upper cavity portion 365d. A second upper stepped portion Du2 is formed at a boundary portion between the thick-diameter-portion upper cavity portion 365a and the second-metal-member upper cavity portion 365e.

An installing step of a method for manufacturing a fiber-reinforced resin tube body according to the third embodiment includes a first installing step and a second installing step. First, as shown by the arrows in FIG. 14, an expandable body 300 is installed in the lower mold 363 in the first installing step. At this time, one end portion 324a of the thin diameter portion 324 is aligned with the first lower stepped portion Dd1. Further, the other end portion 322a of the thick diameter portion 322 is aligned with the second lower stepped portion Dd2. This makes it possible to precisely align the axial position of the expandable body 300 with the lower mold 363. Further, the portion of the first metal member 330 where the fiber 320 is not wound around is installed in the first-metal-member lower cavity portion 364d. Furthermore, the portion of the second metal member 340 where the fiber 320 is not wound around is installed in the second-metal-member lower cavity portion 364e. This makes it possible to precisely align the radial position of the expandable body 300 with the lower mold 363.

Next, as shown by the arrows in FIG. 15, the upper mold 362 is installed and clamped relative to the lower mold 363 in which the expandable body 300 is installed. At this time, the first upper stepped portion Du1 of the upper mold 362 is aligned with the one end portion 324a of the thin diameter portion 324, and the second upper stepped portion Du2 is aligned with the other end portion 322a of the thick diameter portion 322. Further, the first-metal-member upper cavity portion 365d is aligned with the portion of the first metal member 330 where the fiber 320 is not wound around, and the second-metal-member upper cavity portion 365e is aligned with the portion of the second metal member 340 where the fiber 320 is not wound around. This can cause the first metal member 330 and the second metal member 340 to be held between the upper mold 362 and the lower mold 363, so that the axis of the expandable body 330 can be precisely aligned with the axis center of a fiber-reinforced resin tube body to be molded.

It should be noted that the steps in the method for manufacturing a fiber-reinforced resin tube body according to the third embodiment are the same as those described in the first embodiment except for the installing step, and explanations thereof will be omitted.

As described above, in the method for manufacturing a fiber-reinforced resin tube body according to the third embodiment, the first metal member 330 and the second metal member 340 are provided at one end portion and at the other end portion of the expandable body 300, and the fiber 320 is wound around a portion of the first metal member 330 and a portion of the second metal member 340. The mold 360 is composed of a set of the lower mold 363 as a first mold and the upper mold 362 as a second mold. The lower mold 363 has the first-metal-member lower cavity portion 364d and the second-metal-member lower cavity portion 364e, respectively, at positions corresponding to the first metal member 330 and the second metal member 340. Similarly, the upper mold 362 has the first-metal-member upper cavity portion 365d and the second-metal-member upper cavity portion 365e. The first-metal-member lower cavity portion 364d and the second-metal-member lower cavity portion 364e have the first lower stepped portion Dd1 and the second lower stepped portion Dd2 at positions corresponding to both end portions 324a, 322a of the fiber 320. Similarly, the first-metal-member upper cavity portion 365d and the second-metal-member upper cavity portion 365e have the first upper stepped portion Du1 and the second upper stepped portion Du2. The installing step includes: the first installing step of installing the first metal member 330 and the second metal member 340 in the first-metal-member lower cavity portion 364d and the second-metal-member lower cavity portion 364e while positioning both end portions 324a, 322a of the fiber 320, respectively, to the first lower stepped portion Dd1 and the second lower stepped portion Dd2; and the second installing step of installing the first-metal-member upper cavity portion 365d and the second-metal-member upper cavity portion 365e on the first metal member 330 and the second metal member 340 while positioning the first upper stepped portion Du1 and the second upper stepped portion Du2 to both end portions 324a, 322a of the fiber 320.

According to this method, since the portion of the first metal member 330 where the fiber 320 is not wound around is held between the first-metal-member lower cavity portion 364d and the first-metal-member upper cavity portion 365d and the portion of the second metal member 340 where the fiber 320 is not wound around is held between the second-metal-member lower cavity portion 364e and the second-metal-member upper cavity portion 365e, the axis of the expandable body 300 can be precisely aligned with the axis center of the fiber-reinforced resin tube body irrespective of the thickness, and the like, of the fiber 320.

Further, according to this method, since both end portions 324a, 322a of the fiber 320 are positioned to the first lower stepped portion Dd1 and the second lower stepped portion Dd2 when the expandable body 300 is installed in the lower mold 363, the axial position of the expandable body 300 can be precisely aligned with the lower mold 363.

### Fourth Embodiment

Next, a method for manufacturing a fiber-reinforced resin tube body according to a fourth embodiment is described. The fourth embodiment is different from the first embodiment mainly in that a mold is arranged such that the axial direction of an expandable body installed in the mold intersects the horizontal direction. Differences from the first embodiment will be described in detail below.

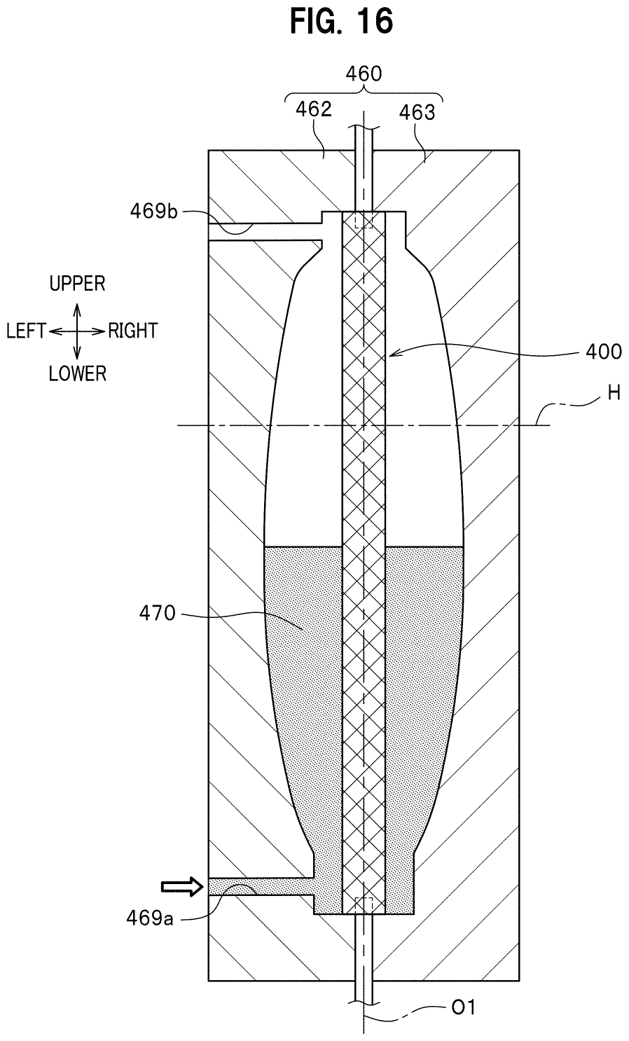

FIG. 16 is a cross-sectional view illustrating a flowing step according to the fourth embodiment.

As shown in FIG. 16, the mold 460 is arranged such that the axis O1 of an expandable body 400 intersects the horizontal line H at 90 degrees. As a result, the axis O1 of the expandable body 400 installed in the mold 460 is directed to the vertical direction. The mold 460 is divided into a left mold 462 and a right mold 463. An inflow gate 469a is provided at a lower side of the left mold 462, and an outflow gate 469b is provided at an upper side of the left mold 462.

The method for manufacturing a fiber-reinforced resin tube body according to the fourth embodiment is carried out such that in the flowing step, the resin 470 flows from the lower side of the mold 460. Accordingly, even if bubbles are generated in the mold 460, it is possible to push these bubbles upward to cause the bubbles to escape from the outflow gate 469b. This can suppress decrease in the product quality due to air bubbles.

Further, since the axis O1 of the expandable body 400 intersects the horizontal line H at 90 degrees, it is possible to suppress deflection of the expandable body 400 as compared with the arrangement in which the expandable body 400 is installed with its axis O1 being directed to the horizontal direction.

It should be noted that in the method for manufacturing a fiber-reinforced resin tube body according to the fourth embodiment, the mold 460 is preferably oriented in such a direction that the axis O1 of the expandable body 400 installed in mold 460 intersects the horizontal line H at 90 degrees. However, the present invention is not limited to this specific arrangement. The angel of intersection at which the axis O1 intersects the horizontal line H may be set appropriately to such an extent that bubbles generated in the mold 460 are pushed up in the flowing step.

It should be noted that the fourth embodiment is the same as the first embodiment except for the orientation of the mold in the flowing step, and thus explanations thereof will be omitted.

Although the first to fourth embodiments of the present invention have been described above with reference to the drawings, the present invention is not limited to these specific embodiments. Various changes and/or modifications may be made without departing from the gist of the present invention. Further, the elements and/or steps of each of the embodiments may be combined together.

What is claimed is:

1. A method for manufacturing a fiber-reinforced resin tube body comprising:
a preparing step of preparing a cylindrical expandable body having fiber wound therearound;
an installing step of installing the expandable body in a mold after the preparing step;
a flowing step of flowing resin into the mold, in which the expandable body is placed, after the installing step; and
an expanding step of expanding the expandable body toward an inner wall of the mold after the flowing step.

2. The method according to claim 1, wherein
a metal member is provided at a part of the expandable body,
the mold is provided with an inflow gate, through which resin is flowed in a position corresponding to the metal member, and
in the flowing step, the resin is flowed into the mold from the inflow gate.

3. The method according to claim 1, wherein
a metal member is provided at a part of the expandable body,
the fiber is wound around a part of the metal member,
the mold is composed of at least two molds including a first mold and a second mold,
the first mold and the second mold each have a recess at a position corresponding to the metal member,
the recess has a stepped portion at a position corresponding to a boundary between a portion of the metal member where the fiber is wound around and a portion of the metal member where the fiber is not wound around, and
the installing step comprises:
a first installing step of installing the metal member in the recess of the first mold while positioning an end of the fiber to the stepped portion of the first mold, and
a second installing step of fitting the recess of the second mold to the metal member installed in the recess of the first mold while positioning the stepped portion of the second mold to the end of the fiber.

4. The method according to claim 1, wherein
after the installing step and before the flowing step, the method comprises a decompressing step of decompressing an inside of the mold.

5. The method according to claim 4, wherein
the decompressing step includes a pressure adjusting step of adjusting pressure inside the expandable body in response to decompressing the inside of the mold.

6. The method according to claim 1, wherein
after the flowing step and before the expanding step, the method comprises an inflow stopping step of stopping an inflow of the resin.

7. The method according to claim 1, wherein
the mold has an inflow gate and an outflow gate that are spaced apart from each other in an axial direction of the expandable body, and
the mold is arranged such that an axis of the expandable body installed in the mold intersects a horizontal direction and that the inflow gate is located below the outflow gate.

8. The method according to claim 2, wherein
a metal member is provided at a part of the expandable body,
the fiber is wound around a part of the metal member,
the mold is composed of at least two molds including a first mold and a second mold,
the first mold and the second mold each have a recess at a position corresponding to the metal member,
the recess has a stepped portion at a position corresponding to a boundary between a portion of the metal member where the fiber is wound around and a portion of the metal member where the fiber is not wound around, and
the installing step comprises:
a first installing step of installing the metal member in the recess of the first mold while positioning an end of the fiber to the stepped portion of the first mold, and
a second installing step of fitting the recess of the second mold to the metal member installed in the recess of the first mold while positioning the stepped portion of the second mold to the end of the fiber.

9. The method according to claim 2, wherein
after the installing step and before the flowing step, the method comprises a decompressing step of decompressing an inside of the mold.

10. The method according to claim 9, wherein
the decompressing step includes a pressure adjusting step of adjusting pressure inside the expandable body in response to decompressing the inside of the mold.

11. The method according to claim 2, wherein
after the flowing step and before the expanding step, the method comprises an inflow stopping step of stopping an inflow of the resin.

12. The method according to claim 2, wherein
the mold has an inflow gate and an outflow gate that are spaced apart from each other in an axial direction of the expandable body, and
the mold is arranged such that an axis of the expandable body installed in the mold intersects a horizontal direction and that the inflow gate is located below the outflow gate.

13. The method according to claim 3, wherein
after the installing step and before the flowing step, the method comprises a decompressing step of decompressing an inside of the mold.

14. The method according to claim 13, wherein
the decompressing step includes a pressure adjusting step of adjusting pressure inside the expandable body in response to decompressing the inside of the mold.

15. The method according to claim 3, wherein
after the flowing step and before the expanding step, the method comprises an inflow stopping step of stopping an inflow of the resin.

16. The method according to claim 3, wherein
the mold has an inflow gate and an outflow gate that are spaced apart from each other in an axial direction of the expandable body, and
the mold is arranged such that an axis of the expandable body installed in the mold intersects a horizontal direction and that the inflow gate is located below the outflow gate.

17. The method according to claim 4, wherein
after the flowing step and before the expanding step, the method comprises an inflow stopping step of stopping an inflow of the resin.

18. The method according to claim 4, wherein
the mold has an inflow gate and an outflow gate that are spaced apart from each other in an axial direction of the expandable body, and
the mold is arranged such that an axis of the expandable body installed in the mold intersects a horizontal direction and that the inflow gate is located below the outflow gate.

19. The method according to claim 5, wherein
after the flowing step and before the expanding step, the method comprises an inflow stopping step of stopping an inflow of the resin.

20. The method according to claim 5, wherein
the mold has an inflow gate and an outflow gate that are spaced apart from each other in an axial direction of the expandable body, and
the mold is arranged such that an axis of the expandable body installed in the mold intersects a horizontal direction and that the inflow gate is located below the outflow gate.
